(19) United States
(12) Patent Application Publication
(10) Pub. No.: US 2009/0037248 A1
(43) Pub. Date: Feb. 5, 2009

(54) AUTOMATED POLLING SYSTEM

(75) Inventors: Steven Sholtis, El Dorado Hills, CA (US); Kenneth Henderson, Folsom, CA (US); Nathan Terres, Oakland, CA (US); Terry LeClair, Fremont, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 11/831,216

(22) Filed: Jul. 31, 2007

(51) Int. Cl. G06F 17/30

(52) U.S. Cl. 705/10

(57) ABSTRACT

Embodiments of the present invention provide a polling system. The system starts by receiving responses to a poll from one or more poll respondents. The system then uses information in a database to determine the reliability of the responses. Next, the system aggregates the poll responses. The system then displays the aggregated poll responses

### BACKGROUND

1. Field of the Invention

Embodiments of the present invention relate to techniques for taking polls. More specifically, embodiments of the present invention relate to techniques for using a polling service application to facilitate the process of taking polls.

2. Related Art

Some polling websites allow users to create a poll that can be provided to potential respondents to collect a set of responses. Then, after a number of responses have been collected, the polling websites can present the users with the responses. Some polling websites also provide tools for analyzing the responses. For example, pollmonkey.com allows users to: create a poll; post the poll to a website where others can respond to it; and review and analyze the responses to the poll.

Unfortunately, responses gathered using online polls can be inaccurate because the websites typically accept poll responses with little or no verification of the respondent's identity. For example, some websites let visitors respond to a poll with no identification. On the other hand, other websites require a password-protected username, but any visitor can establish a username and password with no verification of identity. Because of the lack of identity verification, interested parties can sometimes manipulate the outcome of online polls. For example, parties who have an interest in marketing a commercial product or service can manipulate the outcome of polls that pose questions about the product or service. In addition, the polling websites typically do not take any actions based on the responses of the polls.

### SUMMARY

Embodiments of the present invention provide a polling system. The system starts by receiving responses to a poll from one or more poll respondents. The system then uses information in a database to determine the reliability of the responses. Next, the system aggregates the poll responses. The system then displays the aggregated poll responses.

In some embodiments, prior to receiving the poll responses, the system provides a poll that includes a set of questions to the one or more poll respondents.

In some embodiments, providing the poll involves providing the poll to one or more poll respondents who have indicated an interest in responding to the poll. When providing the poll in this way, the system first determines a set of words and/or phrases in a set of questions in the poll. Next, the system uses the set of words and/or phrases to determine a subject matter of the poll. The system then provides the poll to the one or more poll respondents who have indicated an interest in responding to a poll on the subject matter.

In some embodiments, when providing the poll, the system provides the poll through a website, an email, a file, or through another mechanism. In some embodiments, when receiving responses to the poll, the system receives responses through the website, an email, a file, or another mechanism. In some embodiments, when displaying the aggregated poll responses, the system displays the responses through a website, an email, a file, or another mechanism.

In some embodiments, the system provides a poll-creation mechanism to the client. The client then uses the poll-creation mechanism to generate the set of questions in a predetermined format for the poll. Next, the system receives the set of poll questions generated by the client in the predetermined format.

In some embodiments, the questions in the predetermined format contain key words and/or phrases that facilitate finding a poll of interest.

In some embodiments, when determining the reliability of the responses, the system compares each response to information in the database associated with the poll respondent and related to the poll response. If the information in the database agrees with the response to the poll, the system rates the response as more reliable.

In some embodiments, when aggregating the poll responses, the system creates a statistical profile of the poll responses. In the statistical profile, the system gives more weight to the responses that are rated as more reliable.

In some embodiments, the system receives permission from a poll respondent to use information associated with the poll respondent in the database to provide a response to the poll. The system then determines the response to the poll using information in the database.

In some embodiments, the system provides additional information or performs one or more other operations based on the aggregated poll responses.

### BRIEF DESCRIPTION OF THE FIGURES

FIG. 1 presents a set of network nodes coupled to a network in accordance with embodiments of the present invention.

FIG. 2 presents a block diagram of a polling system in accordance with embodiments of the present invention.

FIG. 3A presents a flowchart illustrating the process of creating a poll using a polling service in accordance with embodiments of the present invention.

FIG. 3B presents a flowchart illustrating the process of responding to a poll in accordance with embodiments of the present invention.

FIG. 3C presents a flowchart illustrating the process of aggregating poll responses in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs), or solid-state devices, such as flash memory, or other volatile and non-volatile storage mediums.

### Computer System

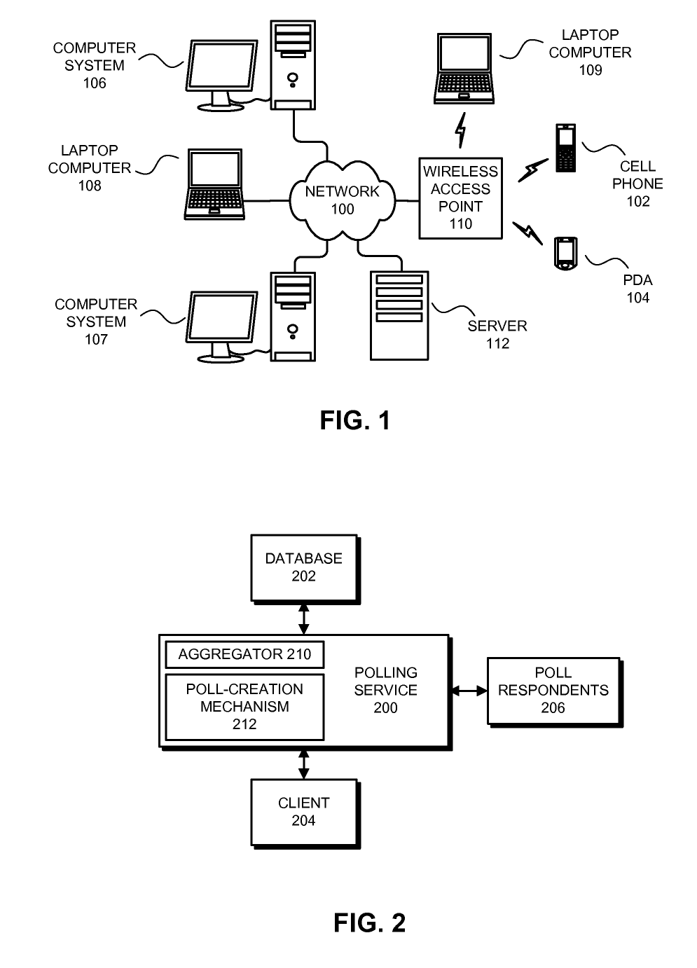

FIG. 1 presents a set of network nodes coupled to network 100 in accordance with embodiments of the present invention. Network 100 can generally include any type of wired or wireless communication channel capable of coupling together network nodes. This includes, but is not limited to, a local area network, a wide area network, or a combination of networks. In some embodiments of the present invention, the network includes the Internet.

Network nodes can generally include any type of communication device capable of communicating with other network nodes via a communication network. This includes, but is not limited to, a computer system 106-107, a server 112, a laptop computer 108-109, a wireless access point 110, a cell phone 102, or a personal digital assistant (PDA) 104. Although a particular combination of networks and network nodes is shown in FIG. 1, alternative embodiments of the present invention can use different combinations of networks and network nodes.

A network node can use network 100 to exchange data with other network nodes. For example, cell phone 102 may be able to acquire web pages and messages from server 112 or may be able to receive email messages from laptop computer 108. In another example, computer system 106 may be able to store web pages and data on server 112, which can then be read by other network nodes.

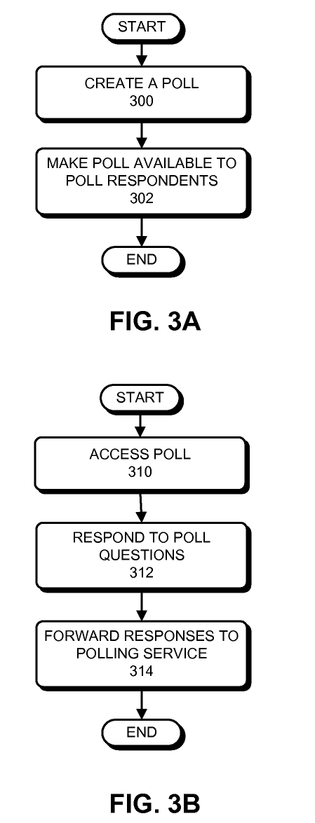

In some embodiments of the present invention, a polling service 200 is an application which runs on server 112 or another suitable network node (see FIG. 2). Polling service 200 can provide an individual and/or organization (collectively, “client” 204) with a poll-creation mechanism 212 that the client 204 can use to create a poll that includes one or more questions about a subject of interest. For example, client 204 can create a poll that includes questions about home appliance reliability, travel services, retirement plans, or medical treatment plans. In alternative embodiments of the present invention, client 204 can create a poll using a poll-creation mechanism 212 that runs locally on a network node (e.g., laptop computer 108) and then can use network 100 to upload the poll to polling service 200.

In some embodiments, polling service 200 then provides the poll to one or more potential poll respondents 206. For example, polling service 200 can place the poll on a website where potential poll respondents 206 respond to polls of interest using computer system 106, PDA 104, or another network node. Alternatively, polling service 200 can deliver the poll to potential poll respondents 206 in an electronic format, such as by email or SMS message on cell phone 102 or another network node. Poll respondents 206 can then upload their responses to polling service 200.

Next, polling service 200 compares the response received from each poll respondent 206 to information about the poll respondent in a database 202 to determine if the response agrees with the information. If so, polling service 200 rates the response as more reliable.

Polling service 200 then aggregates the responses and generates a statistical profile of the responses. When generating the statistical profile, polling service 200 can give more statistical weight to responses that have been rated as more reliable. Next, polling service 200 provides the statistical profile of the responses to the client 204. Polling service 200 can also perform other operations based on the responses to the poll. For example, polling service 200 can make recommendations for commercial products or services to client 204 based on the responses to the poll.

In some embodiments of the present invention, polling service 200 generates a report describing the questions and responses for one or more polls and delivers the report to one or more people who are interested in the questions and responses in the polls. In some embodiments, polling service 200 does this in a manner which protects the identity of poll respondents.

### Polling System

FIG. 2 presents a block diagram of a polling system in accordance with embodiments of the present invention. More specifically, FIG. 2 includes polling service 200, database 202, client 204, and poll respondents 206.

In some embodiments of the present invention, polling service 200 is an application that runs on a network node (such as computer system 106 in FIG. 1) that enables clients 204 to: generate polls on topics of interest; provide the polls to potential poll respondents; and review and analyze responses to the poll. In some embodiments, polling service 200 includes a poll-creation mechanism 212 that assists clients 204 in creating polls and an aggregator 210 which generates statistical profiles from the responses to the poll. Polling service 200 can also include other mechanisms, such as: a website-creation mechanism for generating websites that include the poll-creation mechanism 212, the poll, and/or the statistical profile; a receiving mechanism for receiving responses from poll respondents 206; and other mechanisms for generating polls, analyzing responses, and/or providing statistical profiles. Note that in alternative embodiments, some of the mechanisms run on another network node, but communicate with polling service 200 through network 100.

Client 204 can create a poll that poses one or more questions to poll respondents 206. In return, client 204 can receive a statistical profile (i.e., an aggregated response) of the responses to the poll. In some embodiments of the present invention, client 204 is an individual or organization. For example, client 204 can be a private individual, a medical care provider, a financial institution, or another individual or organization.

Poll respondents 206 respond to the questions in the poll created by client 204. In some embodiments of the present invention, poll respondents 206 are individuals or organizations. For example, poll respondent 206 can be a private individual, a medical care provider, a financial institution, or another individual or organization.

In some embodiments of the present invention, database 202 includes information about poll respondents 206. For example, database 202 can include an individual poll respondent's medical records, financial records, travel records, demographic records, and/or other records. Alternatively, database 202 can include information provided by the poll respondent or another party, such as responses to prior polls, personal likes and dislikes, and/or other information. For an organization, database 202 can contain information about the type of business in which the organization engages, financial records of the organization, prior poll responses of the organization, affiliations with other organizations, and/or other forms of information for or about the organization.

In some embodiments of the present invention, some or all of the information included in database 202 is provided by a source that gives the information an added level of credibility. For example, medical records can be provided by a known healthcare provider or medical insurer. Alternatively, financial records may be provided by a recognized financial institution or from the government (i.e., tax records or bankruptcies). Because this information is not provided by an unknown party or by the poll respondent, the information may be more trustworthy.

In some embodiments of the present invention, clients 204 can use poll-creation mechanism 212 to create polls that include one or more questions on a topic of interest to client 204. For example, clients 204 can create a poll with questions on the effectiveness of a particular smoking cessation program or the quality of a household appliance. In alternative embodiments, poll-creation mechanism 212 provides a website that clients can access to create a poll. In other alternative embodiments, poll-creation mechanism 212 provides a poll template file that can be downloaded, completed, and uploaded by client 204 to create a poll.

In some embodiments of the present invention, poll-creation mechanism 212 runs separately from polling service 200. Hence, clients 204 can run a poll-creation mechanism 212 on a local network node (e.g., laptop computer 108 or PDA 104 from FIG. 1) to create a poll. The completed poll can then be uploaded through network 100 to polling service 200.

In some embodiments of the present invention, poll-creation mechanism 212 guides client 204 while client 204 is creating a poll. For example, poll-creation mechanism 212 can provide recommended words and phrases. For example, a client may have the general question “which is the best airline,” for which poll-creation mechanism 212 may recommend using one or more simpler questions such as “which airline provides the best customer service,” “which airline is most likely to be on time,” and/or “which airline has the most comfortable seats.” Poll-creation mechanism 212 may also recommend using consistent language and phrasing among questions within a poll (or among questions on polls by different clients 204). A poll that includes questions created using the recommended words and phrases is more standardized and hence may be easier for polling service 200 to characterize (i.e., to assign a subject matter) and for poll respondents 206 to find using search applications.

In some embodiments of the present invention, aggregator 210 aggregates responses to polls and creates statistical profiles of the aggregated responses. For example, assuming that polling service 200 has collected 150 responses to a 15-question poll on the effectiveness of a particular drug for reversing male-pattern baldness, aggregator 210 sums up the responses for each question and generates a statistical profile of all 150 responses. Alternatively, aggregator 210 can perform other forms of statistical profiling of poll responses, such as correlating the responses.

In some embodiments of the present invention, aggregator 210 performs a database check for each response when generating the statistical profile. When performing the check, aggregator 210 determines if there exists information in database 202 for the poll respondent that provided the response. If so, aggregator 210 determines if the information is related to the response. If so, aggregator 210 can use the information related to the response to adjust a rating for the response to indicate that the response is more reliable. For example, assuming the poll respondent responded favorably to a poll question on the effectiveness of a particular drug in reversing male-pattern baldness, aggregator 210 can look to see if there is an entry in the database indicating that the poll respondent was successfully treated using the drug. If so, aggregator 210 can adjust a rating for the response to indicate that the response is more reliable. Because the response is marked as more reliable, aggregator 210 can accord more weight to that response when generating the statistical profile. In other words, a response that includes credentials (i.e., a verification using information in the database) can have more effect on the statistical profile than a response that does not include credentials.

In some embodiments of the present invention, poll respondents 206 can use information stored in database 202 to respond to a poll without directly responding to the questions in the poll. In these embodiments, polling service 200 includes a data-extraction mechanism that can determine responses to poll questions using information in database 202. For example, client 204 may have created a poll on the effectiveness of a particular drug in reducing blood cholesterol levels. Assuming that database 202 includes a poll respondent's medical record, which in turn includes information about the poll respondent's treatment using the cholesterol drug, the data-extraction mechanism can extract information from the medical record to form responses to questions such as “what was your final reduction in cholesterol” and “has your cholesterol returned to previous levels since you stopped the regimen.”

In some embodiments of the present invention, poll respondents 206 can give permission for the information in the database to be generally available to provide responses to polls. For example, a poll respondent 206 may give permission for his medical records to be used to respond to any polls related to blood pressure medication. In some embodiments of the present invention, the extraction mechanism can extract and use the information to respond to poll questions in a non-identifiable way (i.e., without names, addresses, or other identifying information for the respondents being disclosed).

In some embodiments of the present invention, polling service 200 includes a results mechanism that uses the responses to polls to perform other operations. For example, assuming that the poll is related to smoking cessation, polling service 200 can select and provide information about one or more smoking cessation options to client 204 based on the poll responses. In this case, the aggregated poll responses may indicate that a nicotine patch (rather than, for example, nicotine gum, exercise, or a holistic program) worked most effectively in helping smokers to quit. Hence, polling service 200 can provide information about the nicotine patch, as well as providing information on where the patch can be acquired, treatment programs, or other such information.

In some embodiments of the present invention, the results mechanism can use information in database 202 to enhance the use of responses to polls. In these embodiments, database 202 contains information related to client 204. For example, the database may indicate that client 204 is very allergic to a certain family of chemicals, so polling service 200 can warn client 204 against a smoking cessation program that uses a patch that includes chemicals from the relevant family of chemicals.

In some embodiments of the present invention, aggregator 210 includes a report-generation mechanism that allows researchers (i.e., including parties other than client 204) to review the questions and responses in the polls for clients 204. In some embodiments of the present invention, the report-generation mechanism generates reports that contain only generalized and non-identifying information.

### Polling Process

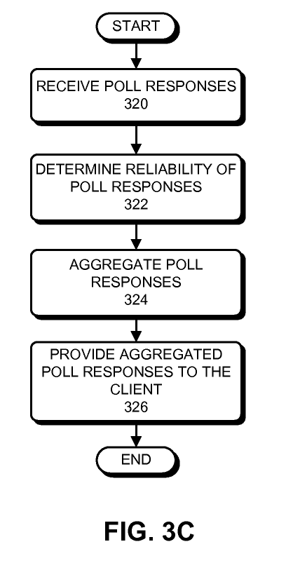

FIGS. 3A-3C present flowcharts illustrating different sub-processes within a polling process in accordance with embodiments of the present invention. More specifically, FIG. 3A presents a flowchart illustrating the process of creating a poll using polling service 200 in accordance with embodiments of the present invention. FIG. 3B presents a flowchart illustrating the process of responding to a poll in accordance with embodiments of the present invention. FIG. 3C presents a flowchart illustrating the process of aggregating the poll responses in accordance with embodiments of the present invention.

As shown in FIG. 3A, the process starts with a client 204 creating a poll (step 300). In some embodiments, client 204 creates the poll using poll-creation mechanism 212. For example, the client may generate a poll with questions on the subject of travel lodging, health care professionals, or the reliability of a particular type of automobile. In some embodiments, poll-creation mechanism 212 can guide the client in creating the questions in the poll. For example, poll-creation mechanism 212 can prompt client 204 to use standard words or phrases in forming questions.

In alternative embodiments, client 204 can create a poll: using a template, manually (e.g., creating questions and entering the questions into a file in a format that can be uploaded to polling service 200), or using another mechanism.

Upon completing the poll, client 204 can make the poll available to poll respondents 206 (step 302). For example, client 204 can provide the completed poll to polling service 200. Polling service 200 can then upload the poll to a website where potential poll respondents can access the poll. In alternative embodiments, client 204 can manually upload the poll to a website where others can access the poll. In other alternative embodiments, client 204 can provide the poll directly to a chosen group of poll respondents. For example, client 204 may be a business that provides polls to its own clients on the quality of service provided by the business.

In some embodiments of the present invention, polling service 200 can maintain a database of potential poll respondents that includes entries that identify the poll subjects that the potential poll respondents may be interested in. Based on the subject matter of questions in the poll, polling service 200 can determine which poll respondents might be interested in responding to the poll. For example, if a potential poll respondent has indicated that they would like to respond to polls related to travel, polling service 200 may forward polls on airline service or travel destinations to the poll respondent.

As shown in FIG. 3B, poll respondents 206 can access the poll (step 310). For example, poll respondents 206 can access a website that includes the poll. Alternatively, poll respondents 206 may access the poll on a local device (such as PDA 104) from a file, in an email, or in another format.

Poll respondents 206 then respond to the poll questions (step 312). In some embodiments, responding to the poll questions involves selecting one of a predetermined group of responses. For example, if a poll question is “did you experience weight loss while drinking diet supplement ‘A’,” the responses may be “yes,” “no,” or “unknown.” Alternatively, if the poll question is “how satisfied were you with your stay at hotel ‘Z’,” the responses may be “completely unsatisfied,” “a little unsatisfied,” “satisfied,” “a little more than satisfied,” and “completely satisfied.” In some embodiments of the present invention, responding to the poll questions may allow a poll respondent to enter text in response to the questions with or without selecting one of the predetermined group of responses.

In some embodiments of the present invention, poll respondents 206 can use their information in database 202 to automatically respond to a poll (with or without manually providing responses to some questions in the poll). In these embodiments, poll respondents 206 give permission for their information in database 202 to be used to respond to the poll. Polling service 200 then determines responses to poll questions using information in database 202.

Next, poll respondents 206 forward the poll responses to polling service 200 (step 314). For example, a poll respondent 206 can click on a submit button after responding to a poll on a website. Alternatively, a poll respondent 206 can upload a file containing the responses to a poll to polling service 200, or can send the poll responses in a predetermined format from a network node (e.g., PDA 104) to polling service 200.

Next, as shown in FIG. 3C, polling service 200 receives the poll responses (step 320).

Polling service 200 then determines the reliability of the poll responses (step 322). When determining the reliability of a poll response, polling service 200 checks database 202 to determine if there is information in the database for the poll respondent who provided the response. If so, and if the information agrees with the response of poll respondent 206, the response can be rated as more reliable. (Note that this step may be skipped where the poll responses have been determined using information from the database 202.)

Polling service 200 then aggregates the poll responses (step 324). During this step, polling service 200 creates a statistical profile of the responses to the survey. For example, polling service 200 may profile the number of “yes,” “no,” or “unknown” responses for a given question. When creating the statistical profile, polling service 200 can give more weight to responses that are rated as more reliable. Next, polling service 200 provides the aggregated poll responses (i.e., the statistical profile) to client 204 (step 326).

In some embodiments of the present invention, when providing the aggregated poll responses to the client, polling service 200 performs one or more additional operations based on the aggregated poll responses. For example, polling service 200 may provide client 204 with other types of information based on the responses to the poll.

In some embodiments of the present invention, polling service 200 generates a report based on the questions and the aggregated responses for one or more polls and provides the report to a researcher or another interested party. In these embodiments, the report may be generated using only non-identifying information.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for polling, comprising:
receiving responses to a poll from one or more poll respondents;
using information in a database to determine the reliability of the responses;
aggregating the poll responses; and
displaying the aggregated poll responses.

2. The method of claim 1, wherein prior to receiving the poll responses, the method further comprises providing a poll that includes a set of questions to the one or more poll respondents.

3. The method of claim 2, wherein providing the poll involves providing the poll to one or more poll respondents who have indicated an interest in responding to the poll by:
determining a set of words and/or phrases in a set of questions in the poll;
using the set of words and/or phrases to determine a subject matter of the poll; and
providing the poll to the one or more poll respondents who have indicated an interest in responding to a poll on the subject matter.

4. The method of claim 3, wherein providing the poll involves providing the poll through a website, an email, a file, or through another mechanism;
wherein receiving responses involves receiving responses through the website, an email, a file, or another mechanism; and
wherein displaying the aggregated poll responses involves displaying the responses through a website, an email, a file, or another mechanism.

5. The method of claim 1, wherein the method further comprises:
providing a poll-creation mechanism to the client, wherein the poll-creation mechanism is used by the client to generate the set of questions in a predetermined format for the poll; and
receiving the set of poll questions generated by the client in the predetermined format.

6. The method of claim 5, wherein the questions in the predetermined format contain key words and/or phrases that facilitate finding a poll of interest.

7. The method of claim 1, wherein determining the reliability of the responses involves:
comparing each response to information in the database associated with the poll respondent and related to the poll response; and
if the information in the database agrees with the response to the poll, rating the response as more reliable.

8. The method of claim 7, wherein aggregating the poll responses involves creating a statistical profile of the poll responses, and wherein the responses that are rated as more reliable are given more weight in the statistical profile.

9. The method of claim 1, wherein the method further comprises:
receiving permission from a poll respondent to use information associated with the poll respondent in the database to provide a response to the poll;
determining the response to the poll using information in the database; and
providing the response to the poll.

10. The method of claim 1, wherein the method further comprises providing additional information or performing one or more other operations based on the aggregated poll responses.

11. An apparatus that facilitates polling, comprising:
a processor;
an execution mechanism on the processor configured to:
receive responses to a poll from one or more poll respondents;
use information in a database to determine the reliability of the responses;
aggregate the poll responses; and
display the aggregated poll responses.

12. The apparatus of claim 11, wherein the execution mechanism is configured to provide a poll that includes a set of questions to the one or more poll respondents.

13. The apparatus of claim 12, wherein the execution mechanism is configured to provide the poll to one or more poll respondents who have indicated an interest in responding to the poll, wherein when providing the poll, the execution mechanism is configured to:
determine a set of words and/or phrases in a set of questions in the poll;
use the set of words and/or phrases to determine a subject matter of the poll; and
provide the poll to the one or more poll respondents who have indicated an interest in responding to a poll on the subject matter.

14. The apparatus of claim 13, wherein when providing the poll, the execution mechanism is configured to provide the poll through a website, an email, a file, or through another mechanism;
wherein when receiving responses, the execution mechanism is configured to receive responses through the website, an email, a file, or another mechanism; and
wherein when displaying the aggregated poll responses to the client, the execution mechanism is configured to display the responses through a website, an email, a file, or another mechanism.

15. The apparatus of claim 11, wherein the execution mechanism is configured to:
provide a poll-creation mechanism to the client, wherein the poll-creation mechanism is used by the client to generate the set of questions in a predetermined format for the poll; and
receive the set of questions generated by the client in the predetermined format.

16. The apparatus of claim 15, wherein the questions in the predetermined format contain key words and/or phrases that facilitate finding a poll of interest.

17. The apparatus of claim 11, wherein when determining the reliability of the responses, the execution mechanism is configured to:
compare each response to information in the database associated with the poll respondent and related to the poll response; and
if the information in the database agrees with the response to the poll, rate the response as more reliable.

18. The apparatus of claim 17, wherein when aggregating the poll responses the execution mechanism is configured to create a statistical profile of the poll responses, wherein the responses that are rated as more reliable are given more weight in the statistical profile.

19. The apparatus of claim 11, wherein the execution mechanism is configured to:
receive permission from a poll respondent to use information associated with the poll respondent in the database to provide a response to the poll;
determine the response to the poll using information in the database; and
provide the response to the poll.

20. The apparatus of claim 11, wherein the execution mechanism is configured to provide additional information or perform one or more other operations based on the aggregated poll responses.

21. A computer-readable storage medium containing instructions that when executed by a computer cause the computer to perform a method for polling, the method comprising:
receiving responses to a poll from one or more poll respondents;
using information in a database to determine the reliability of the responses;
aggregating the poll responses; and
displaying the aggregated poll responses.

22. The computer-readable storage medium of claim 21, wherein prior to receiving the poll responses, the method further comprises providing a poll that includes a set of questions to the one or more poll respondents.

23. The computer-readable storage medium of claim 22, wherein providing the poll involves providing the poll to one or more poll respondents who have indicated an interest in responding to the poll by:
determining a set of words and/or phrases in a set of questions in the poll;
using the set of words and/or phrases to determine a subject matter of the poll; and
providing the poll to the one or more poll respondents who have indicated an interest in responding to a poll on the subject matter.

24. The computer-readable storage medium of claim 23, wherein providing the poll involves providing the poll through a website, an email, a file, or through another mechanism;
wherein receiving responses involves receiving responses through the website, an email, a file, or another mechanism; and
wherein displaying the aggregated poll responses involves displaying the responses through a website, an email, a file, or another mechanism.

25. The computer-readable storage medium of claim 21, wherein the method further comprises:
providing a poll-creation mechanism to the client, wherein the poll-creation mechanism is used by the client to generate the set of questions in a predetermined format for the poll; and
receiving the set of questions generated by the client in the predetermined format.

26. The computer-readable storage medium of claim 25, wherein the questions in the predetermined format contain key words and/or phrases that facilitate finding a poll of interest.

27. The computer-readable storage medium of claim 21, wherein determining the reliability of the responses involves:
comparing each response to information in the database associated with the poll respondent and related to the poll response; and
if the information in the database agrees with the response to the poll, rating the response as more reliable.

28. The computer-readable storage medium of claim 27, wherein aggregating the poll responses involves creating a statistical profile of the poll responses, and wherein the responses that are rated as more reliable are given more weight in the statistical profile.

29. The computer-readable storage medium of claim 21, wherein the method further comprises:
receiving permission from a poll respondent to use information associated with the poll respondent in the database to provide a response to the poll;
determining the response to the poll using information in the database; and
providing the response to the poll.

30. The computer-readable storage medium of claim 21, wherein the method further comprises providing additional information or performing one or more other operations based on the aggregated poll responses.

31. A database that facilitates polling, wherein the database contains information about one or more poll respondents, comprising:
the database;
an execution mechanism within the database;
wherein the execution mechanism is configured to:
receive responses to a poll from a set of poll respondents;
compare the poll responses to information in the database to determine the reliability of the poll responses; and
aggregate the poll responses, which involves generating a statistical profile of the poll responses, wherein more reliable poll responses are given more weight in the statistical profile.

32. The database of claim 31, wherein the execution mechanism is configured to determine a poll respondent's responses from information in the database associated with the respondent.

33. The database of claim 31, wherein the database contains information about a client that created the poll, and wherein the execution mechanism is configured to use the aggregated poll responses and information about the client contained in the database to determine one or more operations to perform based on the aggregated poll responses.
